(19) United States
(12) Patent Application Publication
(10) Pub. No.: US 2025/0098041 A1
(43) Pub. Date: Mar. 20, 2025

(54) COOKING ACCESSORY INCLUDING A SENSOR FOR USE IN A MICROWAVE OVEN

(71) Applicant: Haier US Appliance Solutions, Inc., Wilmington, DE (US)

(72) Inventor: Bagawathkumar Chellappan, Prospect, KY (US)

(21) Appl. No.: 18/470,964

(22) Filed: Sep. 20, 2023

(51) Int. Cl. H05B 6/64; H05B 6/68

(52) U.S. Cl. CPC H05B 6/645; H05B 6/6408; H05B 6/681

(57) ABSTRACT

A cooking accessory for a microwave oven appliance includes a container including an outer tank and defining a receiving cavity for storing a quantity of liquid, the outer tank including an inner surface facing the receiving cavity and an outer surface opposite the inner surface; and a sensor coupled to the container and provided within the receiving cavity, wherein the sensor is positioned within the stored liquid and at least fifteen millimeters away from the inner surface of the outer tank.

### FIELD OF THE INVENTION

The present subject matter relates generally to microwave oven appliances, and more particularly to cooking accessories incorporating sensors for use in microwave oven appliances.

### BACKGROUND OF THE INVENTION

Microwave oven appliances generally include a cabinet that defines a cooking chamber for receipt of food items for cooking. These appliances typically include one or more heating elements for generating energy to heat the food items during a cooking process. For example, microwave ovens typically include at least one source of electromagnetic radiation in the microwave frequency range, such as a cavity magnetron. In order to provide selective access to the cooking chamber and to contain food particles and cooking energy (e.g., microwaves) during a cooking operation, microwave appliances further include a door that is typically pivotally mounted to the cabinet.

Certain foods are best heated utilizing temperature control of a fluid surrounding the food item (e.g., during a sous vide operation). Sous vide is a method of cooking that requires the application of low levels of heat (e.g., 130 to 160 degrees Fahrenheit) over the course of several hours (e.g., one or more hours, such as two or more hours, such as three or more hours, etc.). Even small temperature variations over the duration of the cooking operation can result in drastically different cooking outcomes. In sous vide, food is often cooked by sealing the food a liquid-proof bag and submerging the bag in liquid that is maintained at the desired temperature. However, conventional sous vide assemblies and cooking methods for use in a microwave permit direct exposure of the food to microwave energy, which may quickly result in overcooking or uneven heating. Moreover, electromagnetic radiation from the magnetron of a microwave oven may interfere with sensors positioned within the cooking appliance accommodated within the microwave appliance.

Accordingly, a cooking accessory that obviates one or more of the above-mentioned drawbacks would be beneficial. In particular, a cooking accessory accommodating one or more sensors for use in a microwave appliance would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a microwave oven appliance is provided. The microwave oven appliance may include a cabinet defining a cooking chamber, a door mounted to the cabinet for providing selective access to the cooking chamber, a microwave heating assembly for generating microwave energy within the cooking chamber, a cooking accessory configured for receipt within the cooking chamber for heating one or more items, the cooking accessory including an outer tank forming a receiving cavity for containing a microwavable material, wherein the receiving cavity defines a microwave energy impact zone, a first sensor positioned within the cooking accessory and spaced apart from the outer tank outside of the microwave energy impact zone, the first sensor configured for monitoring a temperature of the microwavable material, and a controller in operative communication with the microwave heating assembly and the first sensor, the controller being configured to perform an operation. The operation may include obtaining a temperature set point for the microwavable material, directing the microwave heating assembly at a predetermined power level in response to obtaining the temperature set point, and obtaining a signal from the first sensor after directing the microwave heating assembly at the predetermined power level.

In another exemplary embodiment of the present disclosure, a method of operating a microwave oven appliance is provided. The microwave oven appliance may include a microwave heating assembly for generating microwave energy, a cooking accessory configured for receipt within the microwave oven appliance for heating one or more items, the cooking accessory including an outer tank forming a receiving cavity for containing a volume of liquid, and a temperature sensor positioned within the cooking accessory. The method may include obtaining a temperature set point for the volume of liquid, directing the microwave heating assembly at a predetermined power level in response to obtaining the temperature set point, and obtaining a temperature signal from the temperature sensor after directing the microwave heating assembly at the predetermined power level.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective front view of a microwave oven appliance in accordance with an example embodiment of the present disclosure.

FIG. 2 provides a perspective view of the exemplary microwave oven of FIG. 1 with the door in an open position according to exemplary embodiments of the present disclosure.

FIG. 3 provides a perspective view of a sous vide assembly that may be used in the exemplary microwave oven of FIG. 1 according to an exemplary embodiment of the present disclosure.

FIG. 4 provides a side, schematic view of the exemplary sous vide assembly of FIG. 3 according to an exemplary embodiment of the present disclosure.

FIG. 5 provides a schematic view of a cooking accessory according to an exemplary aspect of the present disclosure.

FIG. 6 provides a flow chart illustrating a method of operating a microwave oven appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

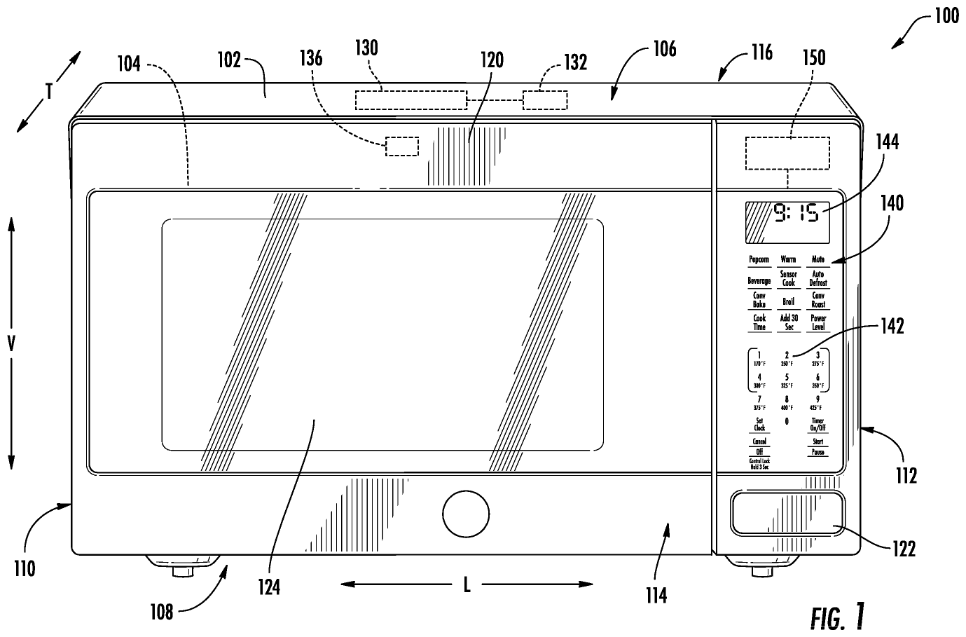

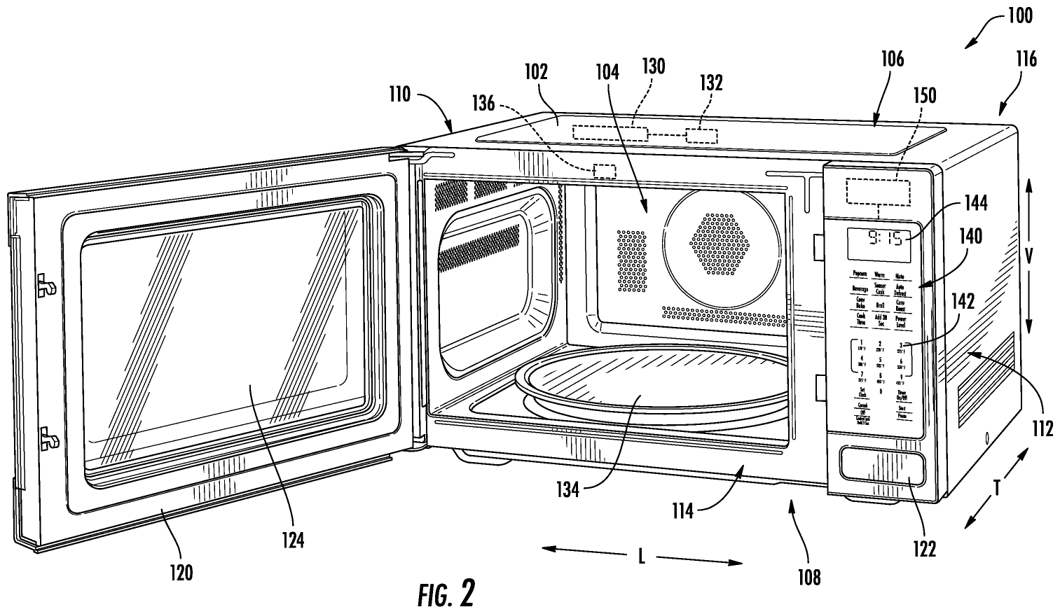

Referring now to the figures, FIG. 1 provides a front view of a microwave oven 100 as may be employed with the present subject matter and FIG. 2 provides a perspective view of microwave oven 100 with the door in the open position. Microwave oven 100 includes an insulated cabinet 102 that defines a cooking chamber 104 for receipt of food items for cooking. As will be understood by those skilled in the art, microwave oven 100 is provided by way of example only, and the present subject matter may be used in any suitable microwave oven, such as a countertop microwave oven, an over-the-range microwave oven, etc. Thus, the example embodiment shown in the figures is not intended to limit the present subject matter to any particular cooking chamber configuration or arrangement.

As illustrated, microwave oven 100 generally defines a vertical direction V, a lateral direction L, and a transverse direction T, each of which is mutually perpendicular, such that an orthogonal coordinate system is generally defined. Cabinet 102 of microwave oven 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

Microwave oven 100 includes a door 120 that is rotatably attached to cabinet 102 in order to permit selective access to cooking chamber 104. A handle may be mounted to door 120 to assist a user with opening and closing door 120 in order to access cooking chamber 104. As an example, a user can pull on the handle mounted to door 120 to open or close door 120 and access cooking chamber 104. Alternatively, microwave oven 100 may include a door release button 122 that disengages or otherwise pushes open door 120 when depressed. Glass windowpanes 124 provide for viewing the contents of cooking chamber 104 when door 120 is closed and also assist with insulating cooking chamber 104.

Microwave oven 100 is generally configured to heat articles, e.g., food or beverages, within cooking chamber 104 using electromagnetic radiation. Microwave appliance 100 may include various components which operate to produce the electromagnetic radiation, as is generally understood. For example, microwave appliance 100 may include a microwave heating assembly 130 which may include a magnetron (such as, for example, a cavity magnetron), a high voltage transformer, a high voltage capacitor and a high voltage diode.

According to exemplary embodiments, microwave oven 100 may further include an inverter power supply 132 that is operably coupled to microwave heating assembly 130 to provide energy from a suitable energy source (such as an electrical outlet) to microwave heating assembly 130, e.g., the magnetron. The magnetron may convert the energy to electromagnetic radiation, specifically microwave radiation. Microwave heating assembly 130 and/or inverter power supply 132 may include other suitable components, such as a capacitor that generally connects the magnetron and power supply, such as via high voltage diode, to a chassis. Microwave radiation produced by the magnetron may also be transmitted through a waveguide to cooking chamber 104.

As would be appreciated by one having ordinary skill in the art, inverter power supply 132 allows the magnetron's analog electric field intensity to be adjusted between various power levels, such as between 10% and 100% of the total power capacity. By contrast, with conventional non-inverter power supplies, the electric field intensity is either 100% or 0%, and power levels are made using a timed duty cycle. For example, a non-inverter power supply set for a 50% power level would turn the magnetron ON at 100% output power for 15 seconds, and then OFF for 15 seconds. At power levels less than 100%, inverter power supply 132 has much better heating uniformity and less penetration depth—ideal heating for sous vide as the inverter power supply heats the water while avoiding direct heating of the food with microwave energy.

The structure and intended function of microwave ovens are generally understood by those of ordinary skill in the art and are not described in further detail herein. According to alternative embodiments, microwave oven may include one or more heating elements, such as electric resistance heating elements, gas burners, other microwave heating elements, halogen heating elements, or suitable combinations thereof, are positioned within cooking chamber 104 for heating cooking chamber 104 and food items positioned therein.

Microwave oven 100 may include additional features to improve heating uniformity and precision. For example, according to an exemplary embodiment, microwave oven 100 includes a turntable 134 rotatably mounted within cooking chamber 104. Turntable 134 may be selectively rotated during a cooking process to ensure improved temperature uniformity for the object being heated. In addition, microwave oven 100 may include an infrared temperature sensing array 136 that can measure temperatures across the entire bottom of the cooking chamber 104. Temperature sensing array 136 may detect temperatures at various distinct temperature locations, may associate certain locations with the food items being cooked, and may use a subset of the temperature data as feedback for regulating inverter power supply 128 and microwave heating assembly 126 for improved precision. For example, temperature sensing array 136 may include one or more infrared sensors mounted to a top of cooking chamber 104 for periodically or continuously monitoring a surface temperature of the water in a sous vide assembly.

Referring again to FIG. 1, a user interface panel 140 and a user input device 142 may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, microwave oven 100 may include a controller 150 in operative communication with the user input device 142. The user interface panel 140 of the microwave oven 100 may be in communication with the controller 150 via, for example, one or more signal lines or shared communication busses, and signals generated in controller 150 operate microwave oven 100 in response to user input via the user input devices 142. Input/Output (“I/O”) signals may be routed between controller 150 and various operational components of microwave oven 100. Operation of microwave oven 100 can be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of microwave oven 100, and controller 150 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Aspects of the present subject matter are generally directed to systems and methods for implementing a sous vide cooking process in a microwave oven, such as microwave oven 100. More particularly, according to exemplary embodiments of the present subject matter, cooking chamber 104 is configured for receipt of a sous vide assembly 200 (e.g., on turntable 134) for facilitating a sous vide cooking process within microwave oven 100. According to exemplary embodiments, turntable 134 is rotated during the sous vide process for improved thermal uniformity. As would be appreciated by one having ordinary skill in the art, a sous vide cooking process is a type of cooking where a food item (such as meat) is vacuum sealed in a bag and submerged in a bath of water maintained at a desired temperature until the meat reaches the desired internal temperature. Notably, precise temperature control is very desirable for sous vide cooking processes.

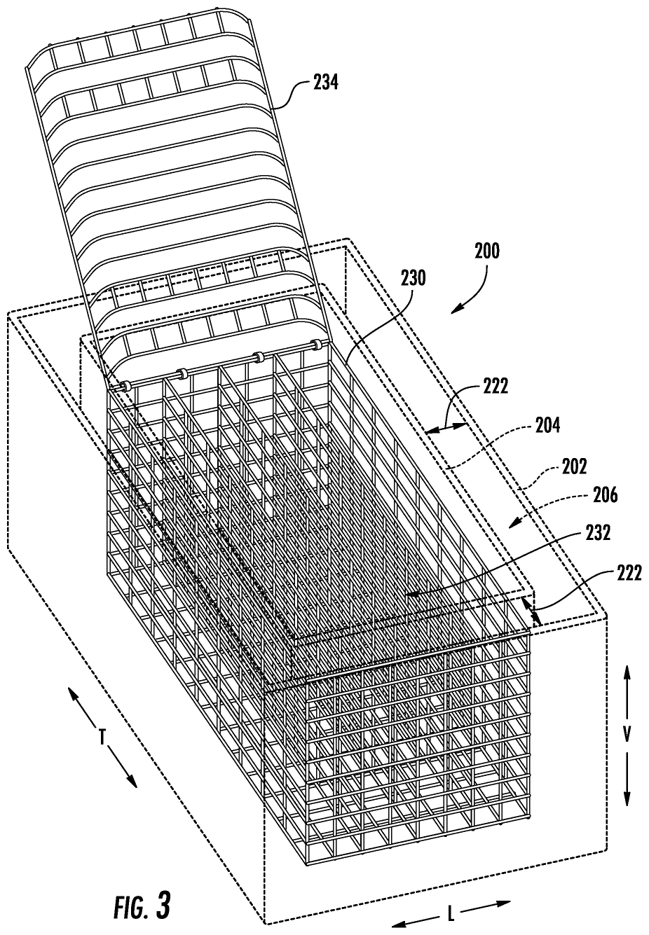

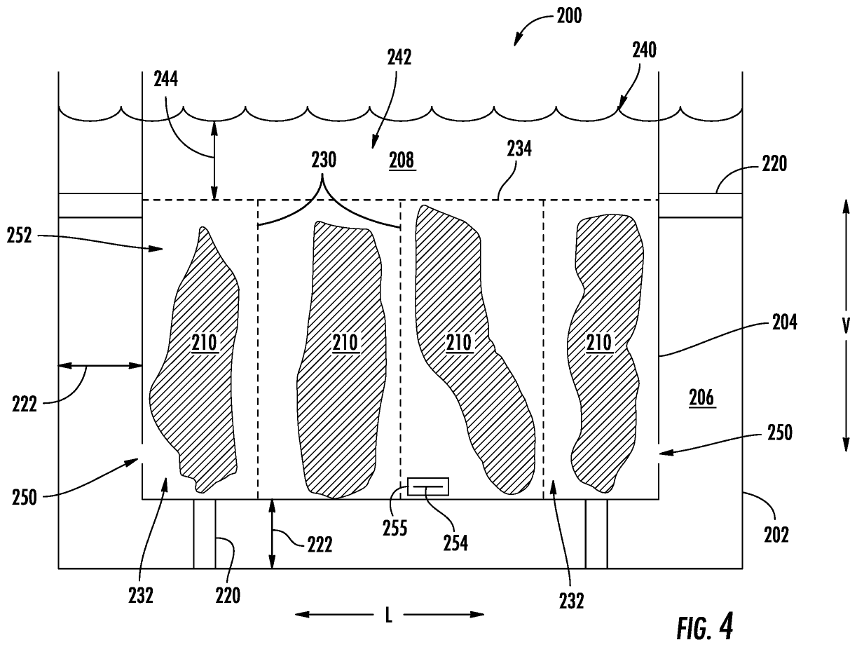

Referring now specifically to FIGS. 3 and 4, sous vide assembly 200 will be described in detail according to an exemplary embodiment of the present subject matter. As mentioned above, sous vide assembly 200 is generally configured for receipt within cooking chamber 104 microwave oven 100 to facilitate a sous vide cooking process. However, it should be appreciated that the present subject matter is not limited to the specific construction of sous vide assembly 200 or to the particular application described, e.g., use within microwave oven 100.

Referring now to the figures, sous vide assembly (or container) 200 generally includes an outer tank (or outer wall) 202 and an inner tank (or inner wall) 204 positioned inside outer tank 202 such that a heating gap (or microwave energy impact zone) 206 is defined between inner tank 204 and outer tank 202. In general, outer tank 202 may be a watertight, open-top container having a bottom wall and a plurality of sidewalls that are joined and configured for containing a volume of liquid (e.g., illustrated herein as a water 208). As will be explained in more detail below, microwave heating assembly 130 is generally configured for heating water 208 to facilitate a sous vide cooking process and cook a food item (e.g., identified herein generally by reference numeral 210) positioned within inner tank 204.

According to the illustrated embodiment, outer tank 202 and inner tank 204 are joined together such that heating gap 206 is maintained throughout the sous vide cooking process. For example, according to the illustrated embodiment, sous vide assembly 200 may include a plurality of tank spacers 220 that are positioned between inner tank 204 and outer tank 202 to maintain heating gap 206. According to the illustrated embodiment, heating gap 206 is substantially constant around the sides and along the bottom of inner tank 204. However, it should be appreciated that heating gap 206 may vary according to alternative embodiments while remaining within the scope present subject matter. In this regard, for example, heating gap 206 may be larger where microwave energy is more intense, and vice versa.

In addition, tank spacers 220 and/or heating gap 206 may have any suitable size or dimension. For example, sous vide assembly 200 is generally sized and configured such that microwave energy penetrates the water 208 that is within heating gap 206 while the water 208 and food items 210 within inner tank 204 are not exposed to direct microwave energy. In this regard, as the microwave energy penetrates water 208, the electric field intensity decreases exponentially. When heating gap 206 is appropriately sized, substantially all of the microwave energy is absorbed within heating gap 206 (e.g., such that there is negligible cooking effect of the microwave energy on the food items 210). Accordingly, heating gap 206 may generally define a gap length 222 that is measured between outer tank 202 and inner tank 204. In this regard, gap length 222 may be measured perpendicular to outer tank 202 or as the shortest distance between a given point on outer tank 202 and the closest point on inner tank 204.

According to exemplary embodiments, gap length 222 may be between about 5 millimeters and 40 millimeters, between about 10 millimeters and 30 millimeters, or about 20 millimeters. It should be appreciated that gap length 222 may vary while remaining within the scope of the present subject matter. For example, the desirable gap length may vary based on the proximity of food items 210 to the outer tank, to the intensity of microwave energy, or based on any other suitable factors.

Notably, because microwave energy is intended only to penetrate into heating gap 206, the water 208 within the inner tank 204 is heated by heat transfer from water 208 within heating gap 206 into inner tank 204. Accordingly, inner tank 204 may be maintained at the desirable temperature by controlling the microwave energy that is imparted into heating gap 206 without exposing the water 208 within inner tank 204 to direct microwave energy. This provides for a more controlled sous vide cooking process within inner tank 204.

To avoid exposure of food items to direct microwave energy, food items 210 are intended to be contained entirely within inner tank 204. More specifically, according to the illustrated embodiment, sous vide assembly 200 further includes one or more vertical dividers 230 that are positioned within inner tank 204 and that extend substantially along the vertical direction V to define a plurality of food chambers 232. For example, according to the illustrated embodiment, sous vide assembly 200 includes three vertical dividers 230 that define four food chambers 232. As illustrated, a food item 210 (e.g., such as a steak) may be positioned within each of the food chamber 232 during the sous vide cooking process.

In general, vertical dividers 230 are illustrated herein as dividing inner tank 204 into four identically-sized compartments. However, it should be appreciated that according to alternative embodiments, any suitable number, size, configuration, and orientation of vertical dividers 230 may be used to form any suitable chamber configuration within inner tank 204. In general, food chambers 232 are sized such that one or more food items 210 may be positioned within each respective chamber 232 while providing sufficient space for water 208 to surround food items 210 and circulate within inner tank 204 for improved temperature uniformity throughout inner tank 204 and even cooking.

In addition, it may be desirable to ensure that food items 210 positioned within inner tank 204 remain submerged within water 208, e.g., to prevent direct exposure of food items 210 to microwave energy. Accordingly, sous vide assembly 200 may further include a cover 234 that is pivotally mounted over the one or more vertical dividers 230 and is movable between an open position and a closed position to provide selective access to the plurality of food chambers 232. For example, according to the exemplary illustrated embodiment, cover 234 is pivotally mounted to the ends of vertical dividers 230 and is movable to a closed position (e.g., as shown in FIG. 4) to define the top end of food chambers 232.

For reasons similar to those described above with respect heating gap 206 it is desirable that a top surface of water 208 is far enough above a top of food chambers 232 such that microwave energy does not directly enter food chambers 232 and cook food items 210. Accordingly, outer tank 202 may generally define a target fill line (e.g., identified generally by reference numeral 240) to which water 208 is filled prior to performing a sous vide cooking process. In addition, an upper heating gap 242 may generally be defined along the vertical direction V between a target fill line 240 and cover 234 when cover 234 is in the closed position. According to exemplary embodiments, upper heating gap 242 may define an upper gap length 244 that is substantially equivalent to or greater than gap length 222. In this manner, all six sides surrounding inner tank 204 and food chambers 232 may have sufficient depth to prevent microwave energy from being directly exposed to food items 210 being cooked during the sous vide process. In this regard, it may be desirable to ensure that cover 234 is fully submerged by the upper heating gap 242, e.g., to ensure that the temperature sensors only measure the temperature of water 208.

As best shown in FIG. 4, sous vide assembly 200 may further include one or more apertures 250 to provide fluid communication between outer tank 202 and inner tank 204. More specifically, inner tank 204 generally defines an internal reservoir 252 (e.g., including food chambers 232 and upper heating gap 242). The one or more apertures 250 provide fluid communication between internal reservoir 252 and heating gap 206. In general, apertures 250 are only intended to ensure that the water levels within outer tank 202 and inner tank 204 remain at the same level (e.g., the target fill line 240). Apertures 250 are generally small enough to maintain such similar water levels without significant water exchange between heating gap 206 and internal reservoir 252. In other words, the sidewalls of inner tank 204 may be solid (with the exception of apertures 250) such that heating gap 206 and internal reservoir 252 are substantially in fluid isolation from each other. Accordingly, nearly all of the heat that is provided into food chambers 232 is provided via conduction through the walls of inner tank 204. In general, this construction improves the water temperature variation within inner tank 204 such that the water temperature may be maintained with precision.

According to exemplary embodiments, vertical dividers 230 and cover 234 may be formed from any suitable materials and have any suitable construction that permits water 208 to flow freely around and within food chambers 232. For example, according to exemplary embodiments, vertical dividers 230 and cover 234 are formed from perforated plates, mesh sheets, lattice structures, interwoven wires, or any other suitable material and construction. In this manner, water 208 within inner tank 204 may circulate freely between and among food chambers 232 such that there are minimal temperature gradients throughout food chambers 232 and inner tank 204.

According to exemplary embodiments, inner tank 204, outer tank 202, vertical dividers 230, and cover 234 may be formed in any suitable manner and using any suitable material. For example, all of these components may be injection molded with a food-grade polymer material. Accordingly, it should be appreciated that various features of sous vide assembly 200 may be formed from any suitably rigid material. For example, according to exemplary embodiments, inner tank 204, outer tank 202, vertical dividers 230, and cover 234 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of sous vide assembly 200 may be formed from any other suitable rigid material.

Sous vide assembly 200 may include one or more sensors 254. Hereinafter, a single sensor 254 will be described in detail, with the understanding that the description may be applied to each of a plurality of potential sensors 254. Sensor 254 may be positioned within inner tank 204. For instance, sensor 254 may be located within one or more food chambers 232. Moreover, sensor 254 may be attached to an inner surface of inner tank 204 (e.g., via one or more fasteners, adhesives, magnets, or the like). Sensor 254 may be configured to sense, monitor, measure, or otherwise determine at least one of a variety of parameters within inner tank 204. According to some embodiments, sensor 254 is a temperature sensor. Additionally or alternatively, one or more wireless electronic devices may be accommodated within inner tank 204. For instance, one or more of a humidity sensor, a camera, an ultrasonic sensor, or the like may be positioned within inner tank 204 (e.g., together with or in place of sensor 254).

Sensor 254 may measure a temperature by contact and/or non-contact methods. For example, sensor 254 may utilize one or more thermocouples, thermistors, optical temperature sensors, infrared temperature sensors, resistance temperature detectors (RTD), etc. Additionally or alternatively, in at least some exemplary embodiments, sensor 254 may include wireless transmitting capabilities (e.g., via a wireless communication module provided within sensor 254). For instance, sensor 254 (e.g., via the wireless communication module provided therein) may be configured to communicate with an appliance (e.g., a controller of an appliance) providing heat thereto (e.g., microwave oven appliance 100 or controller 150 thereof). Sensor 254 may be a waterproof sensor. For instance, sensor 254 may be impervious or otherwise resistant to liquid. In some additional or alternative embodiments, a waterproof enclosure 255 is provided for sensor 254. For instance, a water-tight casing 255 may be provided around sensor 254 to protect sensor 254 from water damage while submerged within water 208.

As used herein, “temperature sensor” or the equivalent is intended to refer to any suitable type of temperature measuring system or device positioned at any suitable location for measuring the desired temperature. Thus, for example, sensor 254 may be any suitable type of temperature sensor, such as a thermistor, a thermocouple, a resistance temperature detector, a semiconductor-based integrated circuit temperature sensors, etc. In addition, sensor 254 may be positioned at any suitable location to sense a temperature within inner tank 204 (e.g., of water 208 within inner tank 204), and may output a signal, such as a voltage, to a controller (such as controller 150 and/or a controller onboard the sensor) that is proportional to and/or indicative of the temperature being measured. Although exemplary positioning of temperature sensors is described herein, it should be appreciated that sous vide assembly 200 (and/or appliance 100) may include any other suitable number, type, and position of temperature, humidity, and/or other sensors according to alternative embodiments.

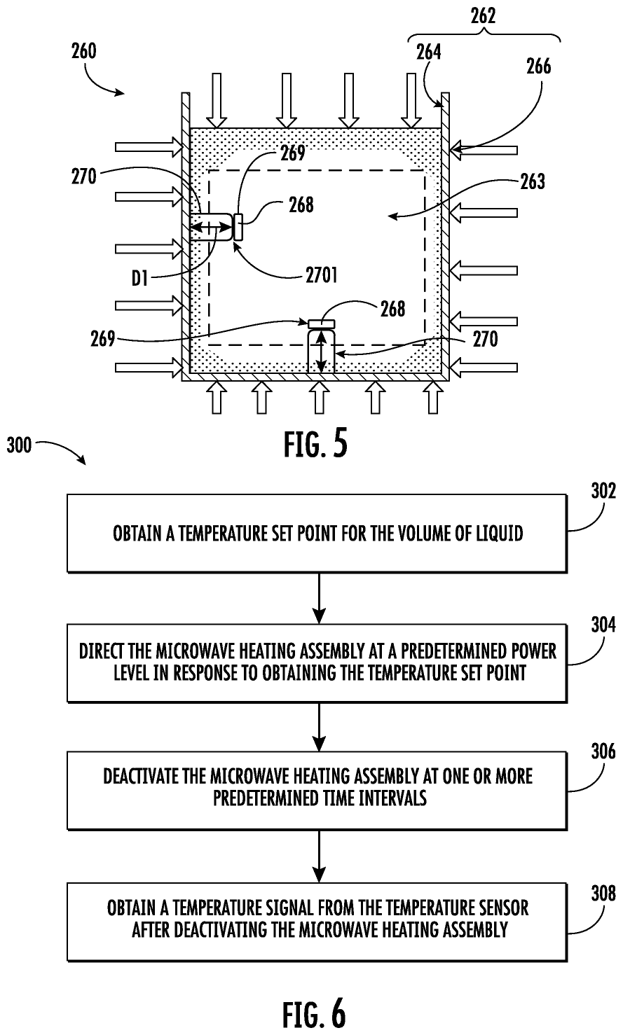

Referring now to FIG. 5, an embodiment of a cooking accessory 260 is provided. Cooking accessory 260 may be a container into which a liquid (e.g., water, tea, coffee, etc.) may be poured or otherwise supplied. Additionally or alternatively, other microwavable materials may be contained within cooking accessory 260 (e.g., soft solid foods, solid foods, viscous liquids, etc.) For instance, cooking accessory may be a mug, a bowl, a cup, or any suitable vessel for storing liquids or any suitable microwavable materials. Cooking accessory 260 may be or include a container 262. Container 262 may be similar to outer tank 202 of sous vide assembly 200 described above. In general, container 262 may be a watertight, open-top container having a bottom wall and a plurality of sidewalls that are joined and configured for containing a volume of liquid (e.g., illustrated herein as water 208). Container 262 may thus define a receiving cavity 263 for storing a quantity of liquid therein. Container 262 may further include an inner surface 264 and an outer surface 266. Inner surface 264 may face receiving cavity 263. Thus, outer surface 266 may be opposite inner surface 264 (e.g., facing outward from receiving cavity 263).

Cooking accessory 260 may include one or more sensors 268. Similar to sensor 254 described above, sensor 268 may be positioned within container 262. For instance, sensor 268 may be located within receiving cavity 263. Sensor 268 may be configured to sense, monitor, measure, or otherwise determine at least one of a variety of parameters within container 262. According to some embodiments, sensor 268 is a temperature sensor. Sensor 268 may measure a temperature by contact and/or non-contact methods. For example, sensor 268 may utilize one or more thermocouples, thermistors, optical temperature sensors, infrared temperature sensors, resistance temperature detectors (RTD), etc. Additionally or alternatively, in at least some exemplary embodiments, sensor 268 may include wireless transmitting capabilities (e.g., via a wireless communication module provided within sensor 268). For instance, sensor 268 (e.g., via the wireless communication module provided therein) may be configured to communicate with an appliance (e.g., a controller of an appliance) providing heat thereto (e.g., microwave oven appliance 100 or controller 150 thereof). Sensor 268 may be a waterproof sensor. For instance, sensor 268 may be impervious or otherwise resistant to liquid. In some additional or alternative embodiments, a waterproof enclosure 269 is provided for sensor 268. For instance, a water-tight casing 269 may be provided around sensor 268 to protect sensor 268 from water damage while submerged within the liquid provided within receiving cavity 263.

Cooking accessory 260 may include a support 270. Support 270 may extend from inner surface 264 (e.g., into receiving cavity 263). For instance, support 270 may protrude from inner surface 264 as an integral piece (e.g., molded) piece of container 262. Support 270 may be a rigid post extending a predetermined distance D1 into receiving cavity 263. In additional or alternative embodiments, support 270 is a flexible post (e.g., malleable). According to at least some embodiments, support 270 extends at least one inch (1″) or about 25 millimeters into receiving cavity 263. In other words, a distal end 2701 of support 270 may be provided at least 25 millimeters away from inner surface 264 of container 262, similar to the embodiment described above. Sensor 268 may be selectively coupled to distal end 2701 of support 270. Advantageously, sensor 268 may be provided at least 25 millimeters away from inner surface 264 of container 262. Additionally or alternatively, cooking accessory 260 may include a lid (e.g., a cover). The lid may selectively cover a top of cooking accessory 260. In some embodiments, support 270 extends from an inner surface of the lid (e.g., along the vertical direction V).

Support 270 may be formed integrally with container 262, or may be a piece separately attached to container 262. For instance, support 270 may be an individual rigid piece connected to container 262 via a fastener (e.g., a screw, bolt, rivet, adhesive, magnet, clip, or the like). Additionally or alternatively, a plurality of supports 270 may be provided within container 262 to accommodate a plurality of sensors 268 therein. Support 270 may extend from a bottom panel of container 262, a sidewall of container 262, or both the bottom panel and one or more sidewalls.

As mentioned above, as microwave energy penetrates water 208 (e.g., after penetrating container 262), the electric field intensity decreases exponentially. Accordingly, when sensor 268 is positioned away from inner surface 264 of container 262, substantially all of the microwave energy is absorbed by the liquid within a one-inch boundary as measured inward from inner surface 264 (e.g., such that there is a negligible effect of the microwave energy on the sensor 268). Advantageously, sensor 268 may avoid damage from the microwave energy while continually monitoring the temperature (or other attribute) of the liquid as the liquid is heated.

Now that the construction of microwave oven appliance 100 and the configuration of controller 150 according to exemplary embodiments have been presented, an exemplary method 300 of operating a microwave oven appliance and cooking accessory will be described. Although the discussion below refers to the exemplary method 300 of operating microwave oven appliance 100, one skilled in the art will appreciate that the exemplary method 300 is applicable to the operation of a variety of other microwave appliances and cooking accessories, including sous vide assemblies. In exemplary embodiments, the various method steps as disclosed herein may be performed by controller 150 or a separate, dedicated controller.

With reference to FIG. 6, at step 302, method 300 may include obtaining a temperature set point for a volume of liquid. In detail, a user may initiate a cooking or heating operation within a microwave appliance (e.g., microwave oven appliance 100) by placing a container (e.g., sous vide assembly 200 or cooking accessory 260) within the cooking cavity of the appliance. The container may include one or more temperature sensors (e.g., sensor 254 or 268). The controller (e.g., controller 150) may obtain a temperature set point for a target temperature of a liquid (or food item placed in the liquid) provided within the container. According to some embodiments, the temperature set point is obtained via a user input (e.g., through a user interface or remote connected device such as a mobile device). According to at least one embodiments, the temperature set point refers to an average temperature of the volume of liquid provided within the container. The temperature of the liquid may be associated with a food item (e.g., a steak) accommodated therein (e.g., for a sous vide cooking operation). Additionally or alternatively, the temperature of the liquid may be a direct temperature of a liquid for consumption (e.g., a mug of coffee, tea, or the like).

At step 304, method 300 may include directing the microwave heating assembly at a predetermined power level in response to obtaining the temperature set point. For instance, the controller may determine an appropriate power level for the microwave oven appliance (e.g., a magnetron) that would reach (and/or maintain) the volume of liquid at the temperature set point. Step 304 may include performing one or more algorithms or predetermined equations to determine an appropriate power level based on factors including the total volume of liquid, a size of the container, the temperature set point, a desired cooking or heating time, or the like. The one or more sensors provided within the container may thus monitor the temperature of the volume of liquid throughout the cooking or heating process.

As mentioned above, the microwave heating assembly may include a variable power magnetron (e.g., a magnetron operable at a variable power level between about 10% and up to 100%). Accordingly, the predetermined power level may include directing or operating the microwave heating assembly constantly at a power level below 100% (e.g., at 20%, 50%, 70%, etc.). Additionally or alternatively, with a non-inverter magnetron, the predetermined power level may include determining a power duty cycle. For instance, the power duty cycle may include a first “on” time at which the magnetron is energized, and a second “off” time at which the magnetron is deenergized.

At step 306, method 300 may include deactivating the microwave heating assembly at one or more predetermined time intervals. In detail, with reference to the non-inverter magnetron example given above, the one or more predetermined time intervals may include a plurality of time intervals at which the microwave heating assembly (e.g., magnetron) is deactivated or deenergized. The microwave heating assembly may be deactivated for a predetermined length of time (e.g., between about 3 seconds and about 15 seconds). The predetermined length of time may vary according to specific embodiments and/or specific heating patterns applied according to the temperature set point.

In deactivating the microwave heating assembly, the microwave energy may be temporarily halted. For instance, the microwave heating assembly may temporarily stop emitting the microwave energy toward the container. Other aspects or features of the microwave oven appliance may continue to operate, such as a turntable, a light, or the like. Additionally or alternatively, at step 306, an operating power level of the microwave heating assembly may be adjusted (e.g., lowered) at the one or more predetermined time intervals. For instance, with reference to the variable power magnetron example given above, a power output of the microwave heating assembly (e.g., magnetron) may be reduced to a predetermined power level at the one or more predetermined time intervals. According to some examples, the predetermined power level is at or below about 20% power. However, the predetermined power level may vary according to specific embodiments, and the disclosure is not limited to the examples given herein.

At step 308, method 300 may include obtaining a temperature signal from the temperature sensor after deactivating the microwave heating assembly. In detail, when the microwave heating assembly is deactivated, a wireless signal may be sent from the temperature sensor within the container to one or more devices. As described above, the microwave heating assembly may deliver or emit a level of microwave energy. By temporarily deactivating the microwave heating assembly, the wireless signal may be sent from the sensor to a remote controller without interference from the microwave energy. The one or more devices may include a controller of the microwave oven appliance, a remote device (e.g., smart phone), etc. The temperature signal may include an immediate temperature reading of the volume of liquid within the container. Additionally or alternatively, the temperature signal may include a graph or table of temperature readings. For instance, while the microwave heating assembly is active, the temperature sensor may monitor the temperature of the volume of liquid. These temperature readings may be temporarily stored (e.g., within an onboard memory of the sensor). Once the microwave heating assembly is deactivated, the temperature history of the volume of liquid may be transmitted to the one or more remote devices.

Upon receiving the temperature signal (or signals) from the sensor(s), method 300 may include determining a heating pattern. In detail, the heating pattern may include future operational parameters of the microwave heating assembly (e.g., for a remainder of the heating or cooking operation). One or more controllers (e.g., within the microwave oven appliance or a remote device) may perform analyses on the temperature signal(s) to determine a heating rate of the volume of liquid. Thus, the heating pattern of the microwave heating assembly may be adjusted in order to reach or maintain the temperature set point. Accordingly, the method 300 may include directing the microwave heating assembly according to the determined heating pattern.

The determined heating pattern may include a power level of the microwave heating assembly. For instance, upon obtaining the temperature signal, the method 300 may extrapolate a heating profile of the volume of liquid within the container. The heating profile may include a rate of temperature change over a period of time. By incorporating the initial predetermined power level of the microwave heating assembly, the method 300 may predict future temperature fluctuations of the volume of liquid. Additionally or alternatively, the determined heating pattern may include an activation length of time at which to drive the microwave heating assembly. Together with the power level of the microwave heating assembly, the activation length of time may be incorporated into additional or subsequent heating phases of the cooking or heating operation. For one example, the method 300 determines a power level and activation length of time to reach the temperature set point. The method 300 may further include determining a power level and activation length of time to maintain the temperature set point (e.g., for a total cooking or heating length of time). Advantageously, a feedback controlled heating operation incorporating precise temperatures within a microwave oven appliance may be performed without interference from the microwave energy.

In some additional or alternative embodiments, the method 300 may include determining a remaining time of the cooking or heating operation after determining the heating pattern. After determining the remaining time, the method 300 may relay or notify the remaining time (e.g., to a user). For instance, the remaining time may be displayed on a display of the appliance. Additionally or alternatively, the remaining time may be transmitted to a remote user device (e.g., phone, tablet, etc.). Thus, the user may be notified of the remaining cooking or heating time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A microwave oven appliance comprising:
a cabinet defining a cooking chamber;
a door mounted to the cabinet for providing selective access to the cooking chamber;
a microwave heating assembly for generating microwave energy within the cooking chamber;
a cooking accessory configured for receipt within the cooking chamber for heating one or more items, the cooking accessory comprising an outer tank forming a receiving cavity for containing a microwavable material, wherein the receiving cavity defines a microwave energy impact zone;
a first sensor positioned within the cooking accessory and spaced apart from the outer tank outside of the microwave energy impact zone, the first sensor configured for monitoring a temperature of the microwavable material; and
a controller in operative communication with the microwave heating assembly and the first sensor, the controller being configured to perform an operation, the operation comprising:
obtaining a temperature set point for the microwavable material;
directing the microwave heating assembly at a predetermined power level in response to obtaining the temperature set point; and
obtaining a signal from the first sensor after directing the microwave heating assembly at the predetermined power level.

2. The microwave oven appliance of claim 1, further comprising:
a support extending from the outer tank into the receiving cavity, wherein the support comprises a post integrally formed with the cooking accessory, and wherein the first sensor is attached to a distal end of the support.

3. The microwave oven appliance of claim 1, wherein the cooking accessory comprises an inner tank spaced apart from the outer tank to form a fluid chamber between the inner tank and the outer tank.

4. The microwave oven appliance of claim 3, wherein the first sensor is attached to an inner surface of the inner tank.

5. The microwave oven appliance of claim 1, wherein the operation further comprises:
determining a heating pattern based on the obtained signal; and
directing the microwave heating assembly according to the determined heating pattern.

6. The microwave oven appliance of claim 5, wherein directing the microwave heating assembly according to the determined heating pattern comprises:
determining a power level at which to drive the microwave heating assembly; and
determining an activation length of time at which to drive the microwave heating assembly.

7. The microwave oven appliance of claim 1, wherein the microwave heating assembly is a magnetron producing electromagnetic microwave radiation.

8. The microwave oven appliance of claim 7, wherein the magnetron is a variable power magnetron, and wherein obtaining a signal from the first sensor comprises:
obtaining the signal from the first sensor when the power level of the magnetron is less than a predetermined power level.

9. The microwave oven appliance of claim 1, wherein the operation further comprises:
deactivating the microwave heating assembly at one or more predetermined intervals after directing the microwave heating assembly at the predetermined power level, and wherein obtaining the signal from the first sensor comprises:
obtaining the signal from the first sensor during at least one of the one or more predetermined time intervals during which the microwave heating assembly is deactivated.

10. The microwave oven appliance of claim 1, wherein the first sensor is a first temperature sensor, wherein the microwave oven appliance further comprises:
a second temperature sensor positioned within the cooking accessory and spaced apart from the outer tank outside of the microwave energy impact zone.

11. A method of operating a microwave oven appliance, the microwave oven appliance comprising a microwave heating assembly for generating microwave energy, a cooking accessory configured for receipt within the microwave oven appliance for heating one or more items, the cooking accessory comprising an outer tank forming a receiving cavity for containing a volume of liquid, and a temperature sensor positioned within the cooking accessory, the method comprising:
obtaining a temperature set point for the volume of liquid;
directing the microwave heating assembly at a predetermined power level in response to obtaining the temperature set point; and
obtaining a temperature signal from the temperature sensor after directing the microwave heating assembly at the predetermined power level.

12. The method of claim 11, further comprising:
a support extending from the outer tank into the receiving cavity, wherein the support comprises a rigid post integrally formed with the cooking accessory, and wherein the temperature sensor is attached to a distal end of the support.

13. The method of claim 11, wherein the cooking accessory comprises an inner tank spaced apart from the outer tank to form a fluid chamber between the inner tank and the outer tank.

14. The method of claim 13, wherein the temperature sensor is attached to an inner surface of the inner tank.

15. The method of claim 11, further comprising:
determining a heating pattern based on the obtained temperature signal; and
directing the microwave heating assembly according to the determined heating pattern.

16. The method of claim 15, wherein directing the microwave heating assembly according to the determined heating pattern comprises:
determining a power level at which to drive the microwave heating assembly; and
determining an activation length of time at which to drive the microwave heating assembly.

17. The method of claim 11, wherein the microwave heating assembly is a magnetron producing electromagnetic microwave radiation.

18. The method of claim 17, wherein the magnetron is a variable power magnetron, and wherein obtaining a temperature signal from the temperature sensor comprises:
obtaining the temperature signal from the temperature sensor when the power level of the magnetron is less than a predetermined power level.

19. The method of claim 11, further comprising:
deactivating the microwave heating assembly at one or more predetermined intervals after directing the microwave heating assembly at the predetermined power level, and wherein obtaining a temperature signal from the temperature sensor comprises:
obtaining the temperature signal from the temperature sensor during at least one of the one or more predetermined time intervals during which the microwave heating assembly is deactivated.

20. A cooking accessory for a microwave oven appliance, the cooking accessory comprising:
a container comprising an outer tank and defining a receiving cavity for storing a quantity of liquid, the outer tank comprising an inner surface facing the receiving cavity and an outer surface opposite the inner surface; and
a sensor coupled to the container and provided within the receiving cavity, wherein the sensor is positioned within the stored quantity of liquid and at least fifteen millimeters away from the inner surface of the outer tank.
